(19) United States
(12) Patent Application Publication
(10) Pub. No.: US 2006/0050713 A1
(43) Pub. Date: Mar. 9, 2006

(54) Adaptive method for activating links in communication networks, in particular for M2PA links

(75) Inventors: Franz Gaiser, Oberkirch (DE); Wolfgang Schrufer, Karlsfeld (DE); Hanns Jurgen Schwarzbauer, Grobenzell (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/217,646

(22) Filed: Sep. 1, 2005

(30) Foreign Application Priority Data
Sep. 6, 2004 (EP) 04021128.6

(51) Int. Cl. H04L 12/56; H04L 12/28

(52) U.S. Cl. 370/395.2

(57) ABSTRACT

The present invention relates to an improved method and network element for activating links in telecommunication networks. The invention relates particularly to the automatic activation of M2PA links in network arrangements, in which network elements with different link activation proving methods are used.

### CROSS REFERENCE TO RELATED APPLICATIONS

This application claims priority to the European application No. 04021128.6, filed Sep. 6, 2004 and which is incorporated by reference herein in its entirety.

### FIELD OF INVENTION

The present invention relates to an improved method and network element for activating links in telecommunication networks. The invention relates particularly to the automatic activation of M2PA links in network arrangements, in which network elements with different link activation proving methods are used.

### SUMMARY OF INVENTION

Modern communication networks generally carry two types of traffic or data. The first type is traffic, which is sent or received by users or subscribers and the user or subscriber is frequently charged for its transmission. This traffic is also referred to as user traffic, user or useful data or subscriber traffic. The second type is traffic which is due to network management and this is frequently referred to as management traffic.

In the field of telecommunication management traffic is also referred to as signaling traffic. Here the term “signaling” relates to the exchange of signaling messages between different network elements such as database servers, local exchanges, transit exchanges and user terminals. One widely known protocol for transmitting such signaling information is the Signaling System 7 (SS7), frequently also referred to as the Common Channel Signaling System 7 (CCS7).

The Signaling System 7 was standardized by the International Telecommunication Union (ITU) in the standard series Q.7xx and complies with all the signaling requirements of current telecommunication networks.

The Signaling System 7 thereby forms an independent network, in which SS7 messages are exchanged between the network elements via bi-directional channels, referred to as links. Signaling takes place outside the (voice) band (out-of-band) and not within the band (in-band) on channels, which are reserved for the user/useful data (e.g. voice). As well as faster connection set-up, this allows a series of functions, e.g. Intelligent Network (IN) services, which can operate in the signaling network, without having to set up parallel bearer connections.

The elements of an SS7 network are known as Signaling Points, which are identified uniquely by a Signaling Point Code (SPC). These point codes are transmitted in the signaling messages between signaling points and designate the source and destination of a message respectively. Each signaling point uses a routing table to select an appropriate signaling route for each message.

The Signaling System 7 uses a protocol stack, in which the hardware and software functions of the SS7 protocol are subdivided into functional abstractions, referred to as levels. These levels can be mapped with some restrictions onto the Open Systems Interconnect (OSI) 7 layer model of the International Standards Organization (ISO).

The lower three levels are referred to as the Message Transfer Part (MTP). MTP level 1 defines the physical, electrical and functional characteristics of the digital signaling link. MTP level 2 ensures the correct end-to-end transmission of a message via a signaling link. MTP level 3 provides the routing for messages between signaling points of the SS7 network.

Current developments are intended to replace signaling based on exclusive and therefore expensive lines with services based on the Internet Protocol (IP). If however IP replaces the MTP level 1, the MTP level 2 used until then also has to be changed. To this end the Internet Engineering Task Force (IETF) proposed and standardized the protocol MTP2 User Peer-to-Peer Adaptation Layer (M2PA), which is based on the Stream Control Transmission Protocol (SCTP), (for development status at the time of the application see the IETF Internet draft draft-ietf-sigtran-m2pa-12.txt dated June 2004).

The aim of combining M2PA/SCTP/IP is to create a protocol, which—like the MTP level 2 of conventional SS7 networks—transports MTP level 3 messages and thereby also responds in the same way as the MTP level 2 from the point of view of the MTP level 3.

Problematically there are two variants of the protocol levels below the MTP level 3, which are specified for different transmission media: the conventional MTP level 2 according to ITU-T Q.703 for the transmission of signaling messages on 64 kbit/s, 1.5 Mbit/s or 2.0 Mbit/s links and the B-ISDN ATM Adaptation Layer according to ITU-T Q.21xx, in particular Q.2140, for transmission via (faster) ATM-based links.

Both variants differ in respect of link alignment. While Q.703 requires the transmission of proving messages before link activation, according to Q.2140 such proving messages are not necessary.

In order for an M2PA link to be activated, the same proving method has to be set on both sides of the link. To date it has only been possible for this setting operation to be carried out manually by the users of both end points of the link. Apart from the manual intervention, which is expensive per se, a database also has to be managed and maintained, in which it is flagged for every link in the communication network which proving method is used by the network elements connected to said link.

One object of the present invention is therefore to specify a method and a network element, which allow automatic activation of an M2PA link irrespective of the proving method used in the network elements connected to the link.

This object is achieved by a method for activating a link between a local network element and a remote network element of a communication network, the activation of links being permitted with and without link proving in the communication network and the method operating with the following steps at least in the local network element:
a) Transmission of at least one activation ready message subject to local conditions for activating the link being in place;
b) Receipt of an activation ready message or link proving request message or link ready message;
c) Transmission of a further activation ready message and a link proving request message and further receipt of a link proving request message or a link ready message, if an activation ready message was received;
d) Transmission of a link ready message and activation of the link, if a link ready message was received; otherwise
e) If a local default does not require link proving: transmission of a link proving request message and a link ready message and activation of the link immediately after receipt of a link ready message, if a link proving request message was received, the link proving request message not being sent in step e), if it was already sent in step c); otherwise
f) If the local default requires link proving: transmission of a link proving request message and implementation of link proving followed by activation of the link, if a link proving request message was received.

The invention also relates to a network element with means for executing this method.

Advantageous embodiments of the invention are specified in the dependent claims.

The invention advantageously allows automatic link activation between network elements, which require or support different activation modes:
a) Network elements requiring proving according to Q.703 (also referred to as strict proving)
b) Network elements not expecting proving according to Q.2140 (also referred to as Strict without Proving)
c) Network elements, which use the adaptive method according to the invention and thereby attempt proving as a default in the event that the remote station also supports the adaptive method (also referred to as Adaptive with Proving)
d) Network elements, which use the adaptive method according to the invention and thereby attempt to omit proving as a default in the event that the remote station also supports the adaptive method (also referred to as Adaptive without Proving).

There is no need for the complex and time-consuming manual setting of the adjacent network elements of a link, as the present invention automatically uses the link activation method appropriate for the respective partner a-d. With the present invention it is therefore possible for M2PA and other protocols to support different link activation methods, without having to modify already installed systems.

The invention thereby complies with the IETF specification for M2PA and allows link activation with all partner methods, irrespective of which side starts activation. The “emergency” alignment method and the “normal” alignment method, which differ primarily in the duration of the proving period during link activation, are also supported.

Exemplary embodiments of the present invention are described in more detail below with reference to 16 figures. FIGS. 1-16 show message sequence diagrams for the activation of links between network elements, which require or support different activation modes.

### BRIEF DESCRIPTION OF THE DRAWINGS

FIG. 1: shows link activation between a network element, which requires link proving according to Q.703, and a further network element, which requires link proving according to Q.703,

FIG. 2: shows failed link activation between a network element, which requires link proving according to Q.703, and a network element, which rejects link proving according to Q.2140,

FIG. 3: shows link activation between a network element, which requires link proving according to Q.703, and a network element, which supports the adaptive method according to the invention and attempts proving according to Q.703 as a default,

FIG. 4: shows link activation between a network element, which requires link proving according to Q.703, and a network element which supports the adaptive method according to the invention and attempts to omit proving according to Q.2140 as a default,

FIG. 5: shows failed link activation between a network element, which rejects link proving according to Q.2140, and a network element, which requires link proving according to Q.703,

FIG. 6: shows link activation between a network element, which rejects link proving according to Q.2140 and a further network element, which rejects link proving according to Q.2140,

FIG. 7: shows link activation between a network element, which rejects link proving according to Q.2140, and a network element, which supports the adaptive method according to the invention and attempts proving according to Q.703 as a default,

FIG. 8: shows link activation between a network element, which rejects link proving according to Q.2140, and a network element, which supports the adaptive method according to the invention and attempts to omit proving according to Q.2140 as a default,

FIG. 9: shows link activation between a network element, which supports the adaptive method according to the invention and attempts proving according to Q.703 as a default and a network element, which requires link proving according to Q.703,

FIG. 10: shows link activation between a network element, which supports the adaptive method according to the invention and attempts proving according to Q.703 as a default and a network element, which rejects link proving according to Q.2140,

FIG. 11: shows link activation between a network element, which supports the adaptive method according to the invention and attempts proving according to Q.703 as a default, and a further network element, which supports the adaptive method according to the invention and attempts proving according to Q.703 as a default,

FIG. 12: shows link activation between a network element, which supports the adaptive method according to the invention and attempts proving according to Q.703 as a default, and a network element, which supports the adaptive method according to the invention and attempts to omit proving according to Q.2140 as a default,

FIG. 13: shows link activation between a network element, which supports the adaptive method according to the invention and attempts to omit proving according to Q.2140 as a default, and a network element, which requires link proving according to Q.703,

FIG. 14: shows link activation between a network element, which supports the adaptive method according to the invention and attempts to omit proving according to Q.2140 as a default, and a network element, which rejects link proving according to Q.2140,

FIG. 15: shows link activation between a network element, which supports the adaptive method according to the invention and attempts proving according to Q.2140 as a default, and a network element, which supports the adaptive method according to the invention and attempts proving according to Q.703 as a default, and

FIG. 16: shows link activation between a network element, which supports the adaptive method according to the invention and attempts to omit proving according to Q.2140 as a default, and a further network element, which supports the adaptive method according to the invention and attempts to omit proving according to Q.2140 as a default.

### DETAILED DESCRIPTION OF THE INVENTION

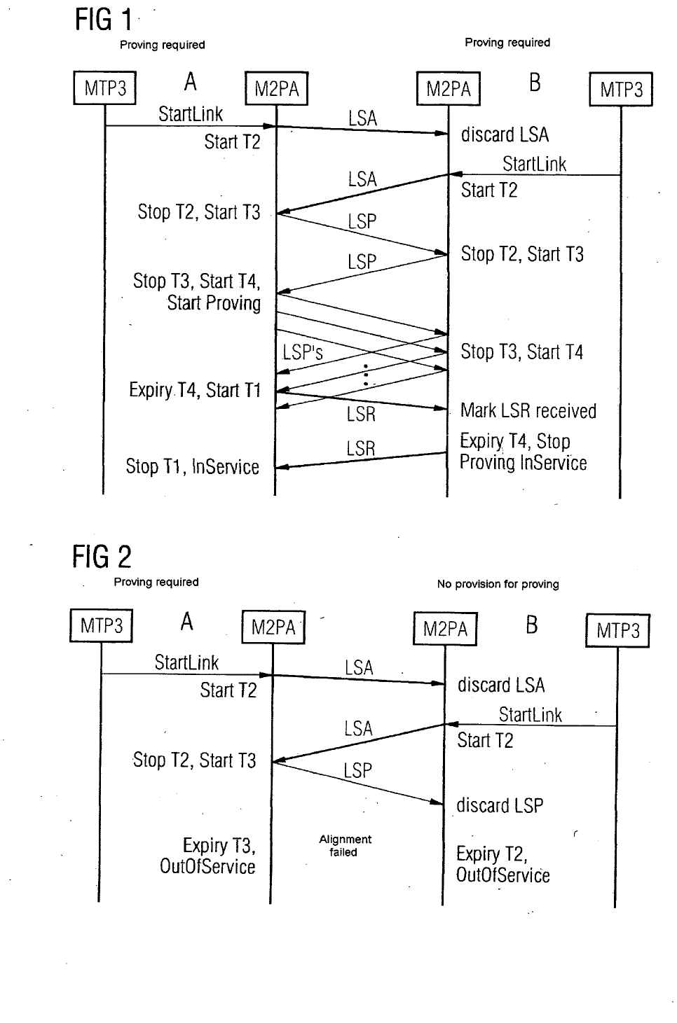

With reference to FIGS. 1, 2, 5 and 6, the sequences which operate during link activation between network elements A and B of the prior art are explained briefly below, said network elements only supporting the methods according to Q.703 or Q.2140.

The following essentially applies to the following detailed description: T1, T2, T3 and T4 are timers, which are defined in the above-mentioned IETF Internet draft or in documents relating to said draft, and which monitor specific phases during link activation. If the internal conditions are in place in a network element, link activation can start, as indicated by the transmission of an activation ready message. In the case of the preferred embodiment, in which M2PA is used as the link protocol, this is a message of the type Link Status: Alignment (LSA). The prerequisites include for example the hardware involved operating without error or existing errors being corrected by hardware or software, the hardware and/or software not being deactivated or blocked by the administrator and the MTP level 3, abbreviated to MTP3, requesting the link activation (shown by the “start link” instruction from MTP3 to M2PA).

If these prerequisites are not in place for a network element, all received messages are discarded, indicated by “discard LSA” at the network element B on receipt of the first message LSA, which is present at B before the “start link” instruction of the MTP3.

The further messages are the link proving request message (for M2PA the message Link Status: Proving (LSP), which is used both for standard proving and for emergency proving) and the link ready message (for M2PA the message Link Status: Ready (LSR)).

Finally it is assumed in the following description that A is already ready to activate the link and B is becoming ready, so the first message considered is the LSA from B to A.

In FIG. 1 link activation takes place between a network element A, which requires link proving according to Q.703, and a further network element B, which requires link proving according to Q.703. B transmits an LSA to A, whereupon A transmits an LSP to B, thereby requesting proving. This corresponds to the local settings at B and B also transmits an LSP. The proving period then starts, within which messages are exchanged across the link to be activated, in order to verify that the link is free from error. This proving period is monitored by timer, in this case T4. After successful completion of the proving period, LSRs are exchanged and the link is activated and can be used to transport MTP level 3 messages.

These basic mechanisms are not examined in more detail here, as they are described in detail in the above-mentioned standards or standard drafts and are well known to the person skilled in the art in the field of the lower SS7 protocol layers.

FIG. 2 shows failed link activation between a network element A, which requires link proving according to Q.703, and a network element B, which in accordance with Q.2140 rejects link proving. Said activation fails, as B receives the message LSP as an unexpected message and discards it, as B expects proving to be omitted and thus an LSR instead of the LSP.

FIG. 5 shows the reverse situation to FIG. 2 with failed link activation between a network element A, which in accordance with Q.2140 rejects link proving, and a network element B, which requires link proving according to Q.703. Said activation fails, as B receives the message LSR as an unexpected message and discards it, as here B expects proving and therefore an LSP instead of the LSR.

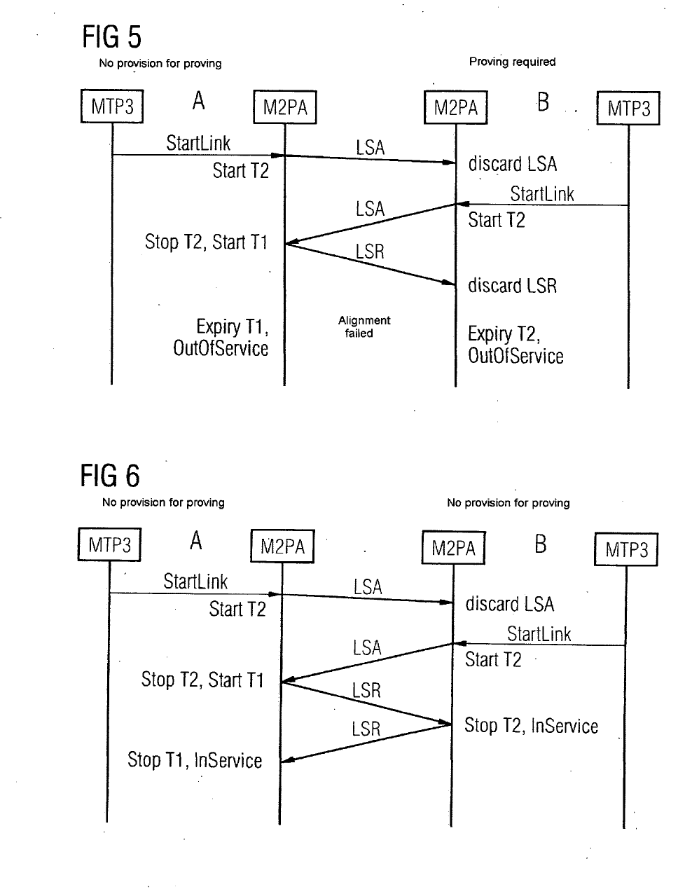

FIG. 6 finally shows successful link activation between a network element A, which rejects link proving according to Q.2140, and a further network element B, which rejects link proving according to Q.2140. The sequence corresponds to the sequence described in relation to FIG. 1, except that the proving period is omitted and instead of exchanging LSPs, LSRs are exchanged immediately for link activation.

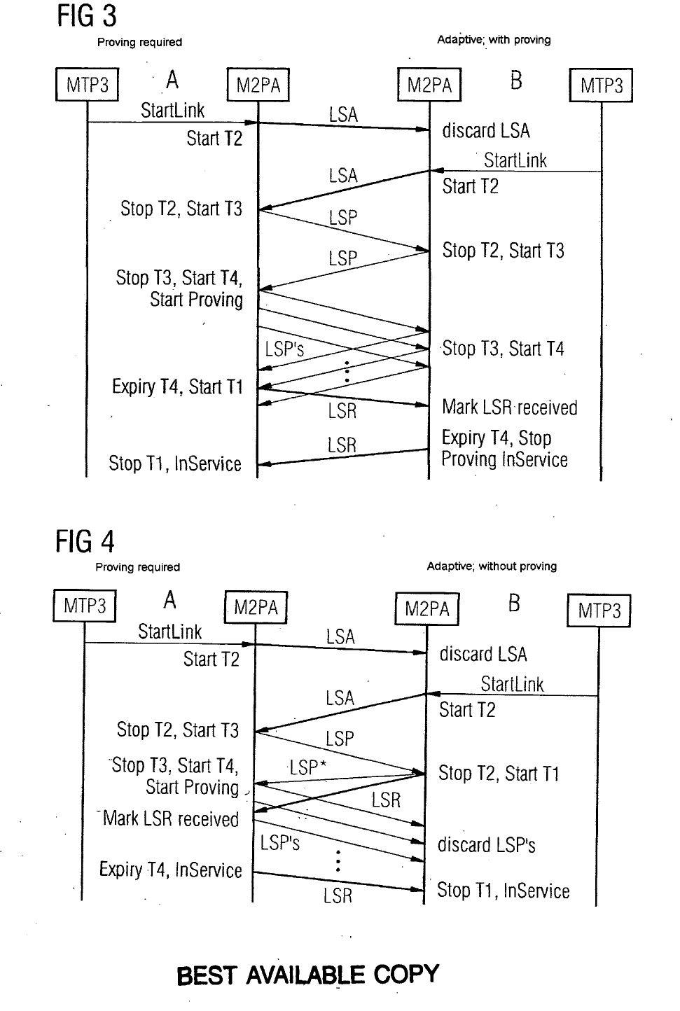

FIGS. 3, 4, 7 and 8 show the interaction of network elements A, which do not support the adaptive method according to the invention, with network elements B, which support the adaptive method according to the invention. Link activation is thereby initiated by the network elements B supporting the adaptive method, in each instance by transmitting an LSA.

In FIG. 3 link activation takes place between a network element A, which requires link proving according to Q.703, and a network element B, which supports the adaptive method according to the invention and attempts proving according to Q.703 as a default. The network element B first transmits an LSA and receives an LSP in response thereto, identifies from this that the network element A requires proving according to Q.703 and responds to the LSP with an LSP. As in this case B itself attempts proving, possible interruption of proving with immediate activation of the link (see details relating to FIG. 4) is not proposed here by B. Rather the proving method is performed, at the end of which the link is activated in the absence of errors.

In FIG. 4 link activation takes place between a network element A, which requires link proving according to Q.703, and a network element B, which supports the adaptive method according to the invention and attempts to omit proving according to Q.2140 as a default. The network element B again sends an LSA first and receives an LSP in response thereto, identifies from this that the network element A requires proving according to Q.703 and again responds to the LSP with an LSP. As in this case however B does not attempt proving, the possible interruption of proving with immediate activation of the link is proposed by transmitting an LSR and the incoming LSP messages are discarded or proved in an alternative. A implements the proving method and at the end of this the link is activated.

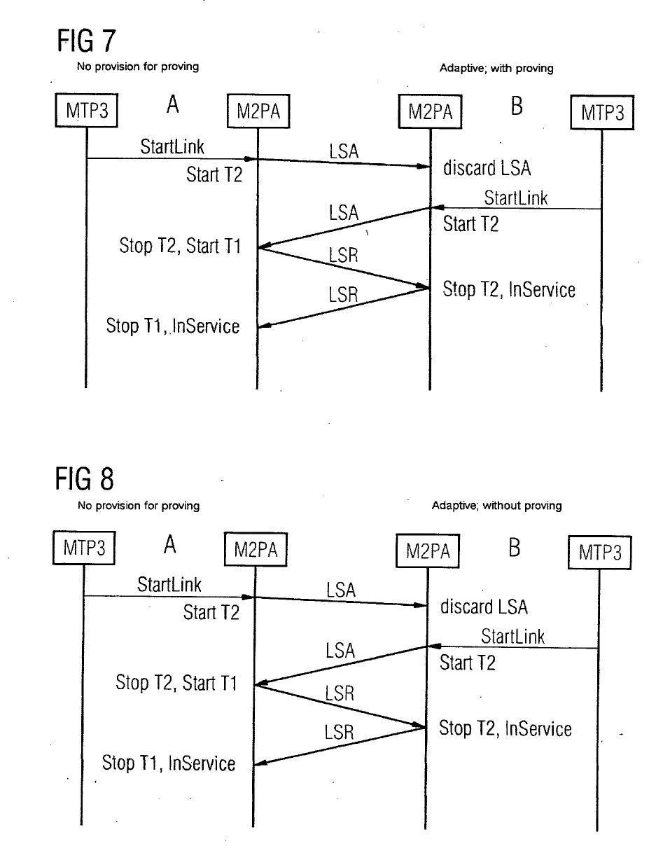

FIG. 7 shows link activation between a network element A, which rejects link proving according to Q.2140, and a network element B, which supports the adaptive method according to the invention and attempts proving according to Q.703 as a default. Network element B first sends an LSA and receives an LSR in response thereto, identifies from this that the network element A requires proving to be omitted and again responds to the LSR with an LSR. The link is activated immediately.

The procedure is the same for the situation shown in FIG. 8, in which link activation takes place between a network element, which rejects link proving according to Q.2140, and a network element, which supports the adaptive method according to the invention and attempts to omit proving according to Q.2140 as a default. B identifies immediately that A only supports the method without proving and therefore does not propose the proving method.

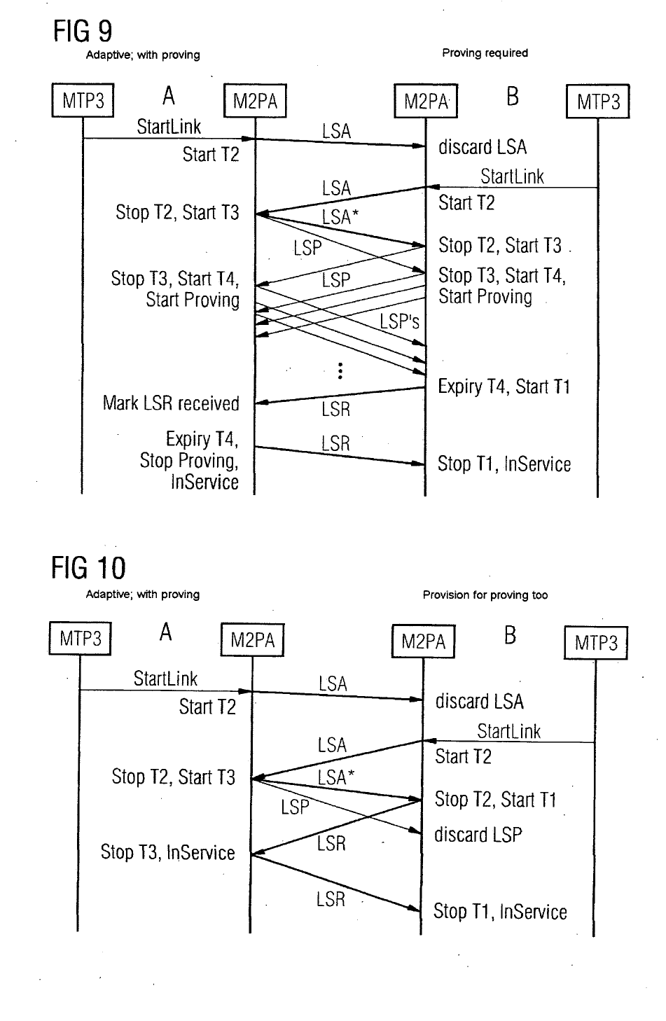

FIGS. 9, 10, 13 and 14 show the interaction of network elements A, which support the adaptive method according to the invention, with network elements B, which do not support the adaptive method according to the invention. Link activation is thereby initiated by the network elements B, which do not support the adaptive method, in each instance by transmitting an LSA.

FIG. 9 shows link activation between a network element A, which supports the adaptive method according to the invention and attempts proving according to Q.703 as a default, and a network element B, which requires link proving according to Q.703. A receives the LSA, with which B starts activation, and transmits an additional message LSA*, to determine which method B is attempting. At the same time or only a very short time thereafter A transmits an LSP, to allow B to start proving, if necessary. This is the case here; the proving period starts, and proving is performed. The link is then activated by an exchange of LSRs.

FIG. 10 shows link activation between a network element A, which supports the adaptive method according to the invention and attempts proving according to Q.703 as a default, and a network element B, which rejects link proving according to Q.2140. A again receives the LSA, with which B starts activation, and sends an additional message LSA*, to determine which method B is attempting. At the same time or only a very short time thereafter, A transmits an LSP, to allow B to start proving, if necessary. This is not the case here; A identifies from receipt of the LSR, which is transmitted by B immediately after the LSA*, that proving should not take place and the link is activated immediately.

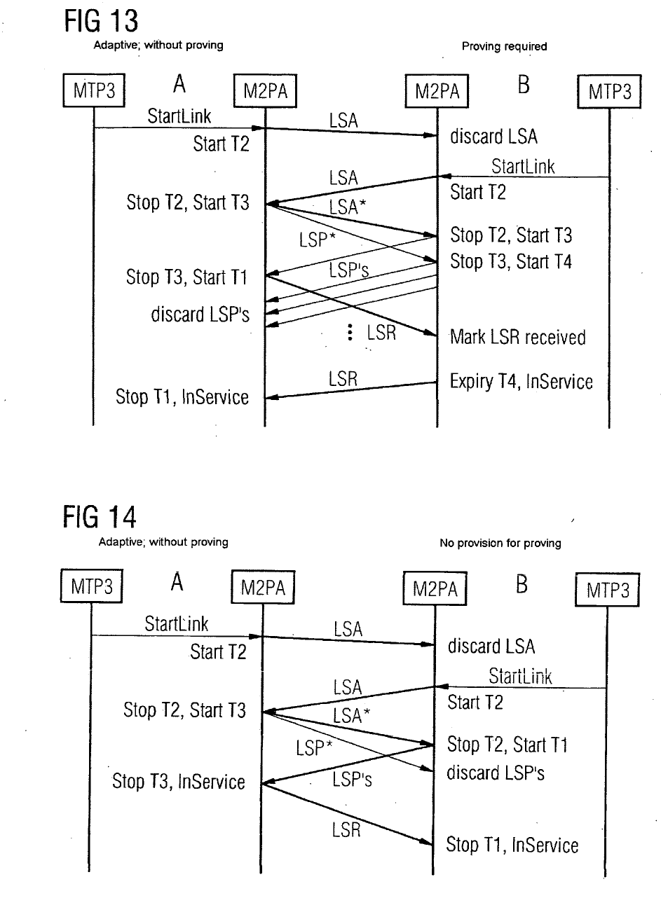

FIGS. 13 and 14 show the same situations as FIGS. 9 and 10, except that the network element A here attempts to omit proving according to Q.2140 as a default. The message LSP transmitted by A is only precautionary here for remote stations for which proving is mandatory and is therefore designated as LSP*. As in FIGS. 9 and 10, the non-adaptive network elements determine the sequence of link activation.

FIGS. 11, 12, 15 and 16 finally show the interaction of network elements A and B, each of which supports the adaptive method according to the invention.

In FIG. 11 link activation takes place between a network element A, which supports the adaptive method according to the invention and attempts proving according to Q.703 as a default, and a further network element B, which supports the adaptive method according to the invention and attempts proving according to Q.703 as a default. B transmits an LSA, which is responded to by A with an LSA* and an LSP. B also sends an LSA*, which is rejected by A, and an LSP, which starts the proving period for A. The link is activated after the end of the proving period.

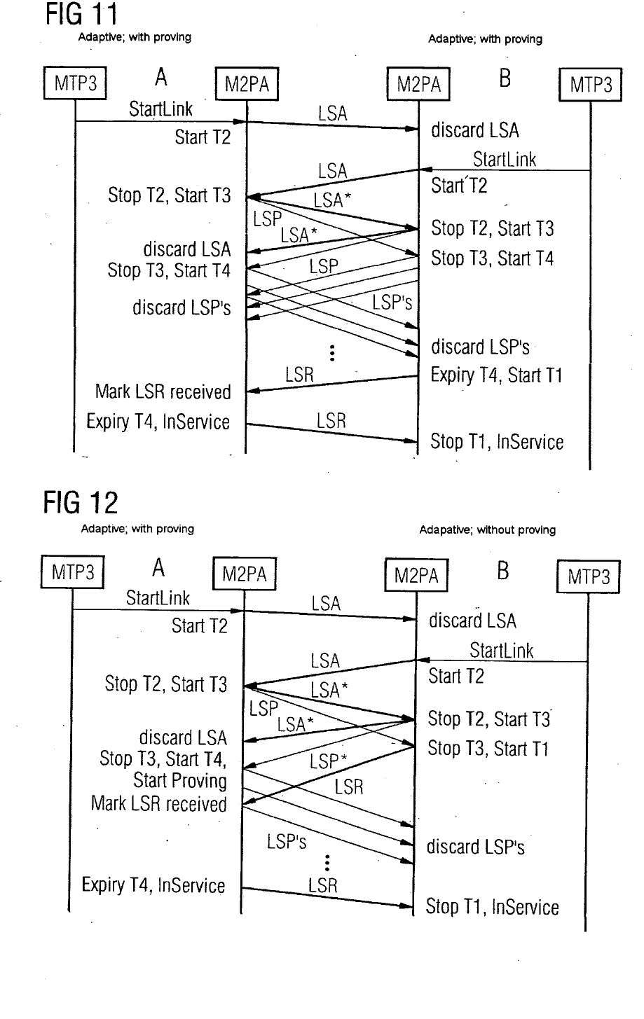

FIG. 12 shows link activation between a network element A, which supports the adaptive method according to the invention and attempts proving according to Q.703 as a default, and a network element B, which supports the adaptive method according to the invention and attempts to omit proving according to Q.2140 as a default. B transmits an LSA, which is responded to by A with an LSA* and an LSP. B also sends an LSA*, which is discarded by A, and a precautionary LSP*, which starts the proving period for A, as well as an LSR, to indicate that B does not require a proving period. A performs proving, at the end of which the link is activated.

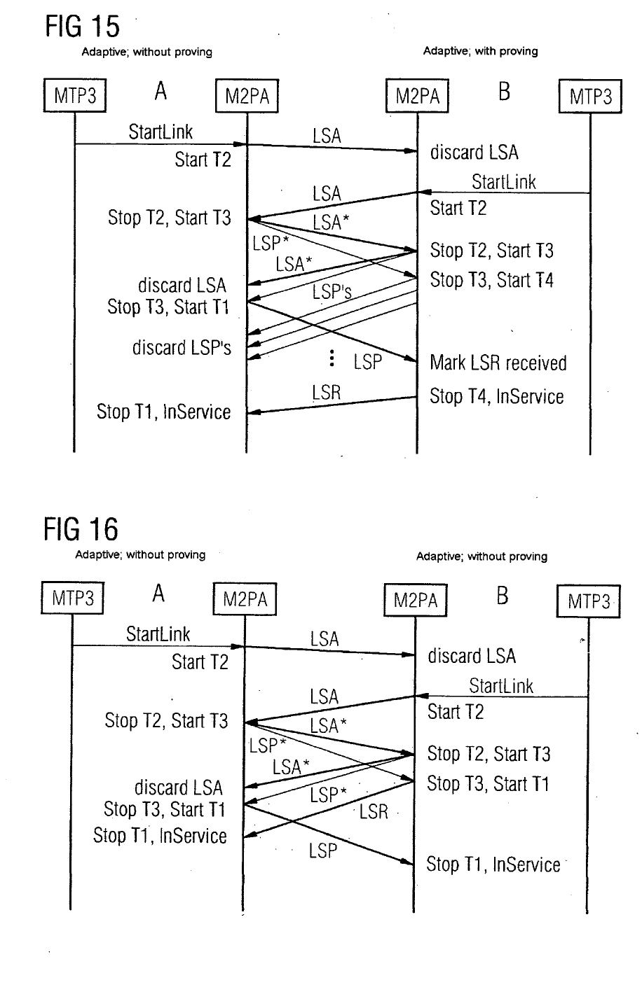

FIG. 15 shows link activation between a network element A, which supports the adaptive method according to the invention and attempts to omit proving according to Q.2140 as a default, and a network element B, which supports the adaptive method according to the invention and attempts proving according to Q.703 as a default. B transmits an LSA, which is responded to by A with an LSA* and a precautionary LSP*. B also sends an LSA*, which is discarded by A, and an LSP, whereupon A sends an LSR, as notification that proving is not necessary for A. Proving is however necessary for B and starts with receipt of the precautionary LSP* from A. B performs proving, at the end of which the link is activated.

FIG. 16 shows link activation between two network elements A and B, which support the adaptive method according to the invention and attempt to omit proving according to Q.2140 as a default. B transmits an LSA, which is responded to by A with an LSA* and a precautionary LSP*. B also transmits an LSA*, which is discarded by A, and an LSP*, whereupon A sends an LSR as notification that proving is not necessary for A. Proving is also not necessary for B, so B also sends an LSR (in response to the precautionary LSP* from A). The link is activated on receipt of the LSR messages.

It should be noted that the messages marked * (LSA*, LSP*) are standard messages (LSA, LSP), which differ from the standard procedure in that they are sent in addition.

Although the invention was described above with reference to the protocol M2PA, the invention is not restricted to this application. Rather the invention can always be used advantageously, if elements are present in a communication network, which either specifically require or specifically exclude a certain proving method. The present invention adjusts adaptively to such behavior.

1. A method for activating a link between a local network element and a remote network element of a communication network, the activation of links being permitted with and without link proving in the communication network, the method comprising:
a) transmitting at least one activation ready message subject to local conditions for activating the link being in place;
b) receiving an activation ready message or link proving request message or link ready message;
c) transmitting a further activation ready message and a link proving request message and further receipt of a link proving request message or a link ready message, if an activation ready message was received;
d) transmitting a link ready message and activating the link, if a link ready message was received; otherwise in case a link ready message was not received:
e. if a local default does not require link proving: transmitting a link proving request message and a link ready message and activating the link immediately after receipt of a link ready message, if a link proving request message was received, the link proving request message not being sent in step e), if it was already sent in step c);
f. if the local default requires link proving: transmitting a link proving request message and implementation of link proving followed by activation of the link, if a link proving request message was received.

2. The method according to claim 1, wherein links according to the protocol M2PA are used in the communication network, the activation ready message being a message Link Status: Alignment LSA, the link proving request message being a message Link Status: Proving LSP, and the link ready message being a message Link Status: Ready LSR.

3. The method according to claim 1, wherein the method is performed in the local network element.

4. A network element of a communication network, in which link activation is permitted with and without link proving, having the following mechanisms for activating a link to a further network element:
a) a mechanism for transmitting at least one activation ready message subject to local conditions for activating the link being in place;
b) a mechanism for receiving an activation ready message or a link proving request message or a link ready message;
c) a mechanism for transmitting a further activation ready message and a link proving request message and further receipt of a link proving request message or a link ready message, if an activation ready message was received;
d) a mechanism for transmitting a link ready message and activation of the link, if a link ready message was received;
e) a mechanism for transmitting a link proving request message and a link ready message and activation of the link immediately after receipt of a link ready message, if link proving is not necessary according to a local default and if a link proving request message was received, the mechanism e) preventing a link proving request message from being transmitted, if such a message was already transmitted by the mechanism according to e);
f) a mechanism for transmitting a link proving request message and implementing link proving followed by link activation, if the local default requires link proving and if a link proving request message was received.

5. The network element according to claim 4, wherein the mechanisms a) to f) are appropriate for activating links according to the protocol M2PA, the activation ready message being a message Link Status: Alignment LSA, the link proving request message being a message Link Status: Proving LSP, and the link ready message being a message Link Status: Ready LSR.
